(19) United States
(12) Patent Application Publication
(10) Pub. No.: US 2005/0108658 A1
(43) Pub. Date: May 19, 2005

(54) System and method for the collection of observations

(75) Inventor: Michel A. Lortie, St-Lazare (CA)

Correspondence Address: MERCHANT & GOULD PC, P.O. BOX 2903, MINNEAPOLIS, MN, 55402-0903, US

(73) Assignee: MRC NETWORKS INC., St-Laurent (CA)

(21) Appl. No.: 11/018,362

(22) Filed: Dec. 20, 2004

Related U.S. Application Data
(63) Continuation-in-part of application No. 09/874,860, filed on Jun. 5, 2001.
(60) Provisional application No. 60/210,471, filed on Jun. 9, 2000.

(51) Int. Cl. G06F 3/00; G06F 19/00

(52) U.S. Cl. 715/835; 715/748; 715/864; 715/808; 715/810; 715/843; 702/5

(57) ABSTRACT

A system for the collection of observations is described which has particular application in the clinical research and aerospace industries. The system has a planning station, for preparing a work package of observations to be collected; a download station, for downloading the work package to at least one primary capture tool, the primary capture tool being used to collect observations according to the work package autonomously; and an upload station, for uploading the observations from the at least one primary capture tool. The invention also concerns a method for collecting observations, as well as a graphical interface therefor. The invention makes use of an atomic database, which obviates the need to reprogram the database when it is to be used for a different set of observations to be collected.

### RELATED APPLICATION

The present application is a Continuation-in-part of U.S. patent application Ser. No. 09/874,860 filed on Jun. 5, 2001, itself claiming priority from U.S. provisional application Ser. No. 60/210,471 filed on Jun. 9, 2000.

### FIELD OF THE INVENTION

The present invention relates to a system and a method for the collection of observations by a plurality of users. The present invention finds particular use in the pharmaceutical research and aircraft maintenance environments, where observations must be rigorously collected, tabulated and analysed.

### DESCRIPTION OF THE PRIOR ART

The field of data collection based on observation is one where the accuracy of measurements is critical. As an example, such observations are necessary for conducting research in new drugs or therapies. In such a case, a drug or treatment is administered to a subject. At regular intervals, a person, the observer, observes the subject and notes any observations. These observations are then collected and analysed in order to evaluate the efficiency, side effects, etc. of the drug or treatment.

Presently, these observations are typically recorded on a piece of paper by the observer. They are subsequently entered on a computer system by an operator, which introduces a degree of error. Such a process is also extremely time consuming.

As another example, in an unrelated field, aircrafts are routinely inspected prior to take-off in order to ensure airworthiness. These inspections are performed using a checklist, generally on a piece of paper, which also introduces a degree of error.

In both examples cited above the observation collecting process is almost entirely dependant on the observer's competency and thoroughness; there is no mechanism to ensure that the observations are exact and collected in the proper manner. This uncertainty may have dire consequences, especially in cases such as aircraft inspection where lives literally depend on the collected observations.

Although some attempts have been made in order to automate the gathering of observations in both the clinical and aerospace industries, none of the solutions proposed have met with commercial success.

Automated data observation collection systems are also known in other fields such as the creation and maintenance of geographic databases. Examples of such systems are for example taught by U.S. Pat. Nos. 5,731,997 (MANSON et al.) and U.S. Pat. No. 6,343,301 (HALT et al.). One drawback of the systems disclosed in both these patents is the fact that they are application specific; it would be impossible to adapt them for a different application without completely transforming its software and possibly hardware so as to render them completely unrecognizable from their original form.

There is therefore a need for a system and a method for the collection of observations which alleviates the above-mentioned drawbacks.

### SUMMARY OF THE INVENTION

It is an object of the invention to provide a system and method for the collection of observations which is portable, easy to handle and more reliable than the prior systems.

In accordance with the invention, this object is achieved with a system for a collection of observations by a plurality of users. This system includes:
a planning station for preparing work packages of observations to be collected by the users, each work package being tailored to a user profile of a corresponding user;
a plurality of primary capture tools each associated with one of the users, each of these primary capture tools being adapted to be used to collect observations according to one of the work packages;
at least one download station, in communication with the planning station, for downloading each of the work packages to the primary capture tool associated with the corresponding user; and
at least one upload station, for uploading the observations from each of the primary capture tool.

Preferably, the user profile includes access and expertise levels of the corresponding user. In this manner it is ensured that the observations are collected by the right person in the right manner.

In one preferred embodiment, the present invention provides an atomic data structure for use with the system and method mentioned above which prevents the need for re-programming the database when migrating from one observation task to another.

In another preferred embodiment, the system above further includes a graphical user interface which minimizes errors during the collection of observations. This is preferably achieved with a graphical user interface for use with the primary capture tool to collect observations of a target, the graphical user interface including a graphical representation of the target and a pick list. In practice the user selects a portion of the graphical representation of the target, upon which a pick list appears. This feature enables said primary capture tool to collect valid observations and measurements.

According to another aspect of the present invention, there is also provided a method for a collection of observations by a plurality of users, this method including the steps of:
a) preparing work packages of observations to be collected by the users, each work package being tailored to a user profile of a corresponding user;
b) downloading each of the work packages to a primary capture tool associated with the corresponding user;
c) having each of the users using the primary capture tool associated therewith to collect observations according to the work package downloaded thereto; and
d) uploading these observations from each of the primary capture tools.

The present invention and its advantages will be more easily understood upon reading the following non-restrictive description of preferred embodiments thereof, made with reference to the appended drawings.

### BRIEF DESCRIPTION OF THE DRAWINGS

FIG. 1 is a schematic representation of a system for collecting observations according to a preferred embodiment of the invention.

FIGS. 2a and 2b are schematic representations of the graphical user interface in a reviewing mode according to one embodiment of the invention; FIG. 2a shows the interface prior to a findings review, and FIG. 2b shows the interface after a findings review.

FIGS. 3a and 3B are schematic representations of the graphical user interface according to an embodiment of the invention, respectively showing a dorsal (FIG. 3a) and a ventral (FIG. 3b) navigational view of a target.

FIGS. 4a, 4b, 5a and 5b are other schematic representations of the graphical user interface, showing a questionnaire. FIG. 4a shows the questionnaire as initially presented; FIG. 4b shows it with the multi-select tool active; FIG. 5a shows the same questionnaire partially answered and FIG. 5b shows the same completed and signed.

FIG. 6 is a schematic representation of the architecture of a system according to a preferred embodiment of the present invention.

FIG. 7 is a schematic representation of an atomic data structure according to a preferred embodiment of the invention.

### DESCRIPTION OF A PREFERRED EMBODIMENT OF THE INVENTION

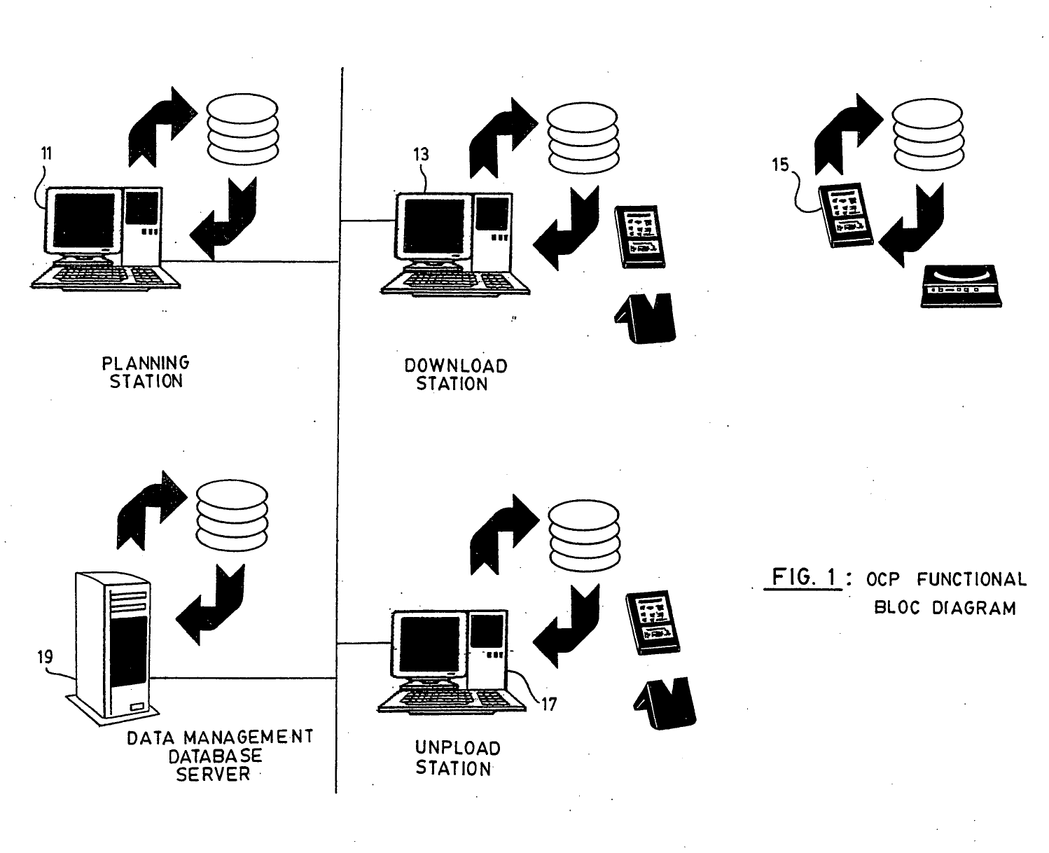

Referring to FIG. 1, there is shown a physical implementation of a system 10 for the collection of observations by a plurality of users according to a preferred embodiment of the present invention. The system 10 is preferably based on hand-held PCs and a traditional PC client-server environment. The elements of the system 10 include:
a planning station 11;
at least one download station 13;
a plurality of primary capture tools 15;
at least one upload station 17; and
a data management database server (AtDB 19);

Each of these elements will be detailed hereinafter.

Planning Station

The planning station 11 is preferably a software-only package that is intended to run on any standard computer supporting a network connection. This station is used by a planning and scheduling group to prepare, based on the work plan, the various work packages (also called Job Tickets) that are to be downloaded to the primary capture tools in support of data collection activities. In the preferred embodiment, the planning station 11 shares its information across the facility's local area network (LAN) through a central database that interconnects all stations, except for the primary capture tool 15. The central database is also bridged to the Data Management database 19 through the various stations and the facility's LAN or WAN communications (dial-up dedicated services or Internet access).

The planning station will allow the definition of an observation lexicon, associate a lexicon with an acquisition cycle (i.e. Time Point and data collection task), prepare a list of authorized technicians (based on the training records and the task at hand) and establish the list of test systems affected by the acquisition cycle. Work packages tailored to the user profile of each of the users making observations are prepared based on this information, and preferably include an observation procedure (which includes the lexicon), and support information such as technical manuals, standard procedures, tooling set-up, previous observations, current observation subject configuration and allowed replacement parts.

The user profile includes any information relevant to each particular user's ability to carry on observations. It may include a user access level according to any appropriate authorization system, and an expertise level of the user with respect to the inspection to be performed. Consequently, the tailoring of the work packages ensures that any observation is only carried out by personnel having the necessary qualifications.

Download Station

The system also includes at least one download station 13, again preferably embodied by a software package running on a standard computer, which is equipped with a docking port for the primary capture tool. Of course, any number of download stations 13 may be provided on a given system depending on the needs of a particular application. In practice, a user first logs in and goes through an authentication procedure on a download station. Access to the system may be password protected and a public/private key system is preferably used to ensure the security of all transactions on the network. The user then makes a selection from a list of available tasks prepared for the current acquisition cycle on the specified inspection task. With the primary capture tool docked, a work package including the required information, such as authorized users, a list of test systems and previous acquisition cycle values, etc is transferred from the network to the primary capture tool's own on-board database. Once the download is complete, the user logs off the download station and proceeds to acquire observation data, for example in a clinic or investigator's office, through the now offline primary capture tool.

Primary Capture Tools

Each user is provided with a primary capture tool on which to record his observations. It preferably consists of a handheld computer device such as a tablet computer running a windowing style operating system and proprietary software. Of course, different types of capture tools may be used within a same system. While each observation and or measurement task which can be accomplished with the present invention requires specific-to-task software modules, the primary capture tool also offers some across-the-board functions. In one exemplary embodiment, for the clinical trials market, these standard functions include:
a digital signature module allowing the Investigator-of-record to review and confirm the content of the Case Report Form and, through encryption techniques, apply a digital signature to the document and force future changes to be audited. Any future change will automatically remove the investigator's signature;
an automatic audit trail module that captures the time and nature of any change to any committed observation or measurement as well as the ID of the user making the change and a reason for the change. The audit trail will also capture the action that caused the data record to be modified; and
a standardized set of capture tools that can be tailored, through data definitions, to support most Clinical Trial requirements. Custom capture tools are possible but usually unnecessary. The use of standard tools significantly reduces the preparation time needed to field the acquisition units.

The use of hand-held or tablet PCs as the primary capture tool is highly advantageous over known prior art systems, for example in the field of clinical trials in the pharmaceutical industry. It eliminates the need for tethered operation of the capture computer in the examination room. In the pre-clinical setting, this un-tethered operation reduces the danger of cross contamination of studies caused by the transfer of computer carts from room to room. In the clinical setting, the size and mobility of the device make for greater acceptability by investigators given the limited space in which they operate. In aircraft inspections, the un-tethered operation means that the data capture tool can be used as the only collection device even deep within the aircraft's structure where outside radio frequency signals are blocked.

The weight advantage the hardware has over a laptop is considerable (as little as 250 g vs. 6 to 8 kg). This weight advantage translates into increased user acceptance given that the technician or investigator typically carries the device on his/her person for a full shift (8 hours).

Upload Station

One or more upload stations 17 are provided as the final link in the data capture chain. Like the other LAN-based components of the system of the present invention, the upload station is preferably embodied by a software package that runs on a standard computer. Its primary function is to recover the observations captured on the primary capture tool. It may optionally prepare the primary capture tool for its next capture cycle.

In the preferred embodiment, the user profile and work package are again validated upon login in at the upload station. The upload station additionally monitors the collected data for any data excursions, which are defined as valid observations, made by the technician in the field, which have a value (i.e. temperature or pressure or colour etc.) beyond the range of expected values for a given observation. For example, water could be observed to boil at 95° C. rather than 100° C.; this value is surprising but possible if, for example, the water container was at higher elevation. In this case, the system would ask the observer to confirm the actual value as correct before committing it to the database. This greatly reduces the time required to deal with out-of-range and unusual data queries while ensuring maximum integrity of the data collected and the collection process itself. Advantageously, these limits and expected values are not “hard coded” into the program; rather, the allowed values or anticipated ranges as well as any conditional processing of the questionnaires based on the observation (i.e. If the answer to question 5 is 12 or greater then process questionnaire 6 starting at question 105 otherwise go to question 6 in the original questionnaire) are parameters that are included in the download of information that controls the observation cycle.

Once the uploaded data is cleared of any ambiguities, the upload station will affect the transfer of the data to the Data Management database and update the Job Ticket's status within the central database.

Database Server

In a preferred embodiment of the invention, the system preferably includes a data management database server 19, hosting a data management database.

Preferably, this data management database presents an “atomic” data structure as explained below.

While the use of relational database technology in the storage and retrieval of information collected through manual and automated means is a generalized approach in most data processing environments, this technology inherently requires that the data being stored and retrieved be modeled as to its type, size and inter-relationships (meta data). By using a data abstraction model that reduces the data elements to their most simple expression (hence the use of the term “atomic” in describing the database), the need for modeling the data inter-relationships is removed from the database environment and placed within the data elements themselves. In effect, the traditional meta data is transformed into data. This has a consequence that virtually any type of data can be captured by the system of the present invention and stored within the AtDB without the need of programming. This adaptability allows the system of the present embodiment to be retargeted from industries such as Drug Development to Aerospace to Financial Management and Insurance Claims processing without the need to reprogram or modify the database.

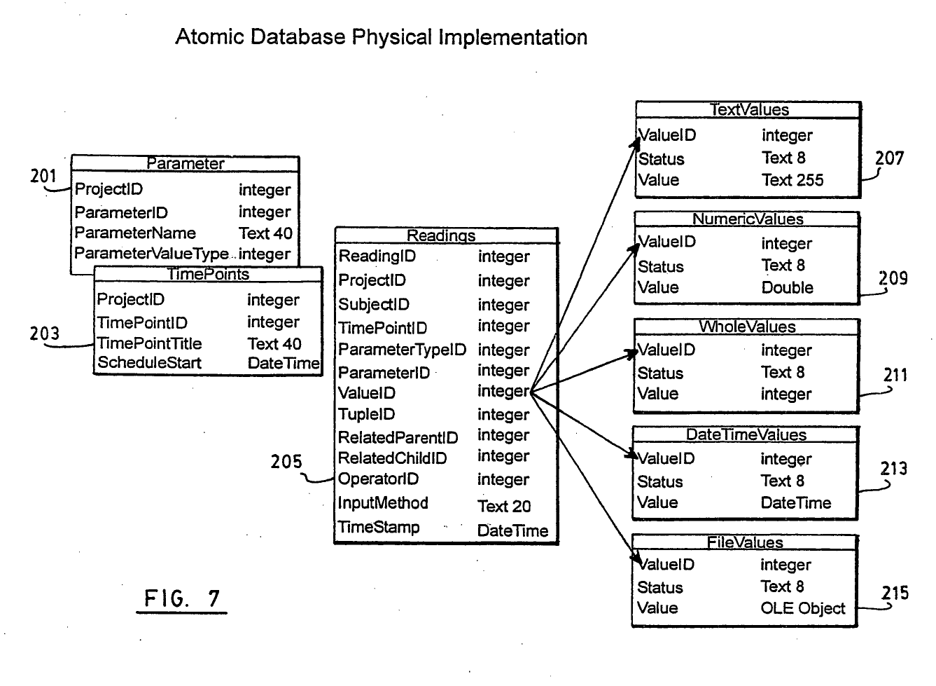

The data management database therefore preferably includes the use of a fixed data abstraction (see FIG. 7) that reduces any reading or observation made with the system of the present invention to a series of single element records that carry within them the rules for recreating their association with other records. In other words, each observation collected is divided into storage elements each containing a single information, including pointers linking associated storage elements for reconstructing the original observations.

This obviates the need for the database management system to understand the nature of the information stored within it and, as a result, renders the database generic. Since the generic database does not need to be programmed, the system of the present invention can be tailored to a specific capture activity more rapidly by users than other systems that rely on programming resources to convert the data relationships into relational structures through data modeling techniques.

FIG. 7 presents an example of a physical implementation of the database within Microsoft Corporation's ADO™ data management environment. The elements include:
Parameter table 201;
TimePoints table 203;
Readings table 205;
TextValue table 207;
NumericValue table 209;
WholeValue table 211;
DateTimeValue table 213; and
FileValue table 215.

The Parameter table 201 provides a User-specified name (ParameterName) for each data element stored in the Readings table along with the necessary typing (ParameterValueType) to allow the system to correctly select the appropriate storage table.

For those cases where the information collected by the system is repetitive (e.g. similar data collected on repeat visits to a clinician or data collected at every preventative maintenance inspection of an aircraft), the TimePoints table is provided to allow the user to assign a name (TimePointTitle) and a schedule (ScheduleStart) to each occurrence of the data capture event.

The Readings table 205 holds all the information associated to a data element save for the actual value of the specific element. Given that the storage element is, in all cases, specific to the nature of the information held (i.e. picture, floating point number, integer value, text string), the readings table holds a pointer to the specific storage element (ParameterID) as well as a type indicator (ParameterTypeID) used to specify the storage element type.

The Readings table 205 holds an index to the TimePoints table 203 (TimePointID), which allows similar data elements (ParameterID|ParameterTypeID) to be differentiated on an occurrence basis.

The Readings table 205 maintains, through the use of pointer fields (RelatedParentID and RelatedChildID), the linkages necessary to reconstruct the associations between itself and other Readings records. These fields hold, as data, the information normally understood to be the database's meta data. The fields form a linked list.

The Readings table 205 maintains information relating to the identity of the person making the observation (OperatorID), the time at which the observation was made (TimeStamp) and the manner in which the observation was made (InputMethod) as part of the data management and security system.

Each of the data element tables (i.e. TextValue 207, NumericValue 209, WholeValue 211, DateTimeValue 213 and FileValue table 215) is structured similarly in that they have an identifier field (ValueID) which serves to uniquely identify the value held and which is copied to the Readings table's ValueID field, a value field (Value) which holds the data element's value and a status field (Status) used by the system to determine the phase within the capture process each record is in currently. The Value field is typed according to the data element type it holds.

Of course, the structure above is given as an example only and is in no way limitative to the scope of the present invention.

The implementation of a generic or atomic data structure within the primary data store eliminates the need to program a unique structure and capture software for each study. The “atomic” nature of the data store is derived from the fact that the relationship between data elements (meta data) normally held in the table structure of relational databases is converted to data within the AtDB and is held there in exactly the same fashion as the information data. This transformation allows the AtDB to hold virtually any type of measurement or observation without the need of specific to purpose programming.

One skilled in the art will readily understand that while the various subsystems of the system of the present invention have been presented as interconnected applications running from separate machines, the implementation need not be thus. In fact, it is possible to run all the LAN/WAN based functions from a single machine to which the primary capture tool's docking station is connected. Conversely, the functions can be run through wide area technologies such as dial-up networks and the Internet. The topology of any given implementation is more a matter of overall size of the operation and effective use of resources than any particular constraints associated with the system's design.

The system of the present invention is a data capture system and as such relies on the commercial Data Management System to which it is interfaced to provide tabulation and reporting features. A companion product to the system with which it is fully integrated and from which observations and measurements can be tabulated is also contemplated.

### METHOD ACCORDING TO A PREFERRED EMBODIMENT

The present invention further provides a method for the collection of observations by a plurality of users. The method includes the following steps:
a) preparing work packages of observations to be collected by said users, each work package being tailored to a user profile of a corresponding user. The user profile preferably includes access and expertise levels of the user;
b) downloading each of said work packages to a primary capture tool associated with the corresponding user;
c) having each of said users using the primary capture tool associated therewith to collect observations according to the work package downloaded thereto; and
d) uploading said observations from each of said primary capture tool.

### EXEMPLARY EMBODIMENT

An example of implementation of the present invention as applied to clinical trials will now be given in more details with reference to the appended drawings.

The OCP supports the definition, acquisition and transfer of Case Report Form data. This data will include clinical observations made by the investigator as well as basic physical parameters and vital signs with either user input or direct connection to electronic instruments.

The OCP will also address particular study needs with enhanced sensor connectivity allowing for the direct connection of low-level sensors such as temperature, pressure, ECG and EKG, always maintaining the data capture focus of the system.

In use, a user will initiate an observation cycle by logging on to the Download Station and, after authentication, transfer, from the AtDB, the required Protocol and associated data elements. Once the transfer is complete, the observation cycle is accomplished stand-alone without any further support from the general computing environment, including the network. The observation cycle will be closed with the transfer of the observations from the primary capture tool to the holding database which is designed to accept AtDB style data records. Each transfer will trigger a verification and AtDB load cycle through the use of the Upload Station. In operation, the architecture will support, through programmed execution, the collection of observations and measurements.

It is intended that all observations and measurements be captured through the use of programmed user interactions with the primary capture tool. However in order to provide the flexibility required to quickly adapt to client requests for peculiar data captures and one time only data captures, the architecture of the present invention will also support the input of observations through the use of double entry forms and an interface called XLIF.

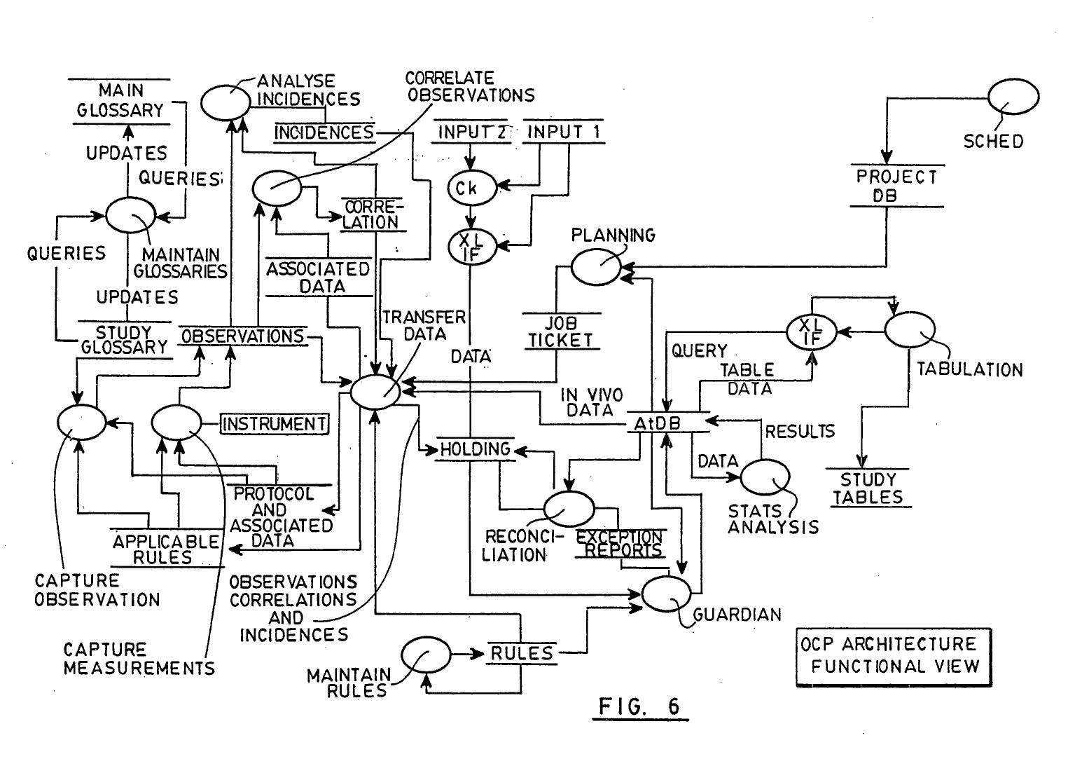

Reference will be now be made to FIG. 6, where the functional architecture of the system of the present invention, the <<transfer data>> function provides all necessary bi-directional interfaces between the User and the system. These interfaces include: User and Assignment authentication, Protocol data transfer, Associated data transfer, observations transfer, rules and glossary transfers. <<Capture observations>> provides the necessary User interface to support observation cycle specific capture of human observations driven by observation cycle specific glossaries and protocol requirements. <<Capture measurements>> (primary capture tool) will, under similar constraints to <<capture observations>>, collects measurements directly from electronic instruments connected via special-to-purpose interface cards. <<Correlate observations>> and <<Analyse incidences>> represent basic analyses that might be carried out concurrently (primary capture tool) within the observation cycle on the same computer or once the observation cycle is completed (Upload Station) and using a different computer. The <<Maintain glossaries>> (Planning Station) is a function that allows the User to add, modify and/or delete, under the constraints of applicable regulations, the vocabulary used to describe the observations made in the course of an observation cycle. Finally, the <<Planning>> function (Planning Station) allows the user to derive job tickets (data collection tasks) from the production planning system.

The system according to the present invention is a highly portable hardware/software system specifically designed to meet the needs of technical staff involved in the collection of data in closely regulated industries such as drug development and air transport services to the public.

While these markets are supported by existing data management systems, the system is according to the Applicant, unique in its focus on the acquisition portion of the data management process. This narrow focus allows the system to benefit from single purpose optimizations that are impractical in larger multi-function implementations.

Once collected, the data can be transferred to any of the popular data management systems currently on the market. In the case of Clinical Trials, this means any SQL-92 compliant database manager or SAS solution. By providing specific gateways to commercial data management systems, the system of the present invention makes it possible for the end user community to improve their data capture quality and efficiency without incurring the time and expense associated with acquisition, training and validation of an entirely new system. Rather the validation burden is limited to the confirmation of acquired measurements and observations and the training, which is directed at the technical staff and is highly visual with direct programmatic support for industry “best practices”.

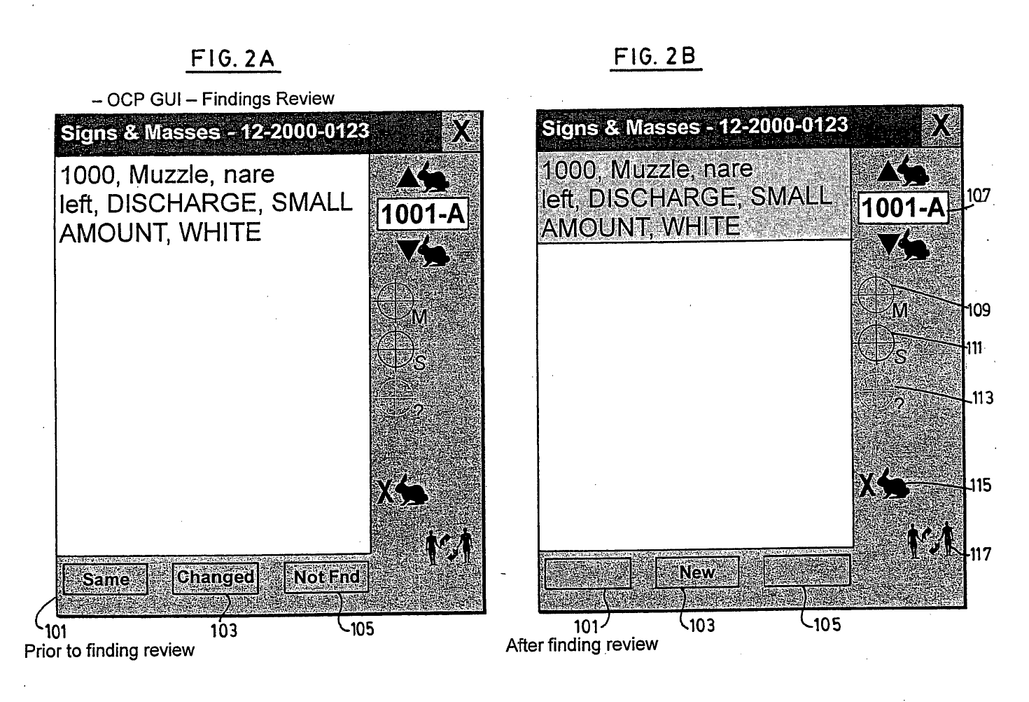

The use of traditional (e.g. Windows®) graphical user interfaces (GUI) within the data capture environment is not new, nor is the use of specific graphical presentations for navigation of the capture process. The system's GUI shown in FIGS. 2a, 2b, 3a, 3b, 4a, 4b, 5a, 5b is however novel in that it uses the presentation of drawings coupled to specialized software capture “tools” as its exclusive interface to the user. This approach is critical to the architecture's goal of simplifying, streamlining and improving the overall effectiveness of the process automation provided by the system.

In the context of a clinical trial, the GUI include as elements:

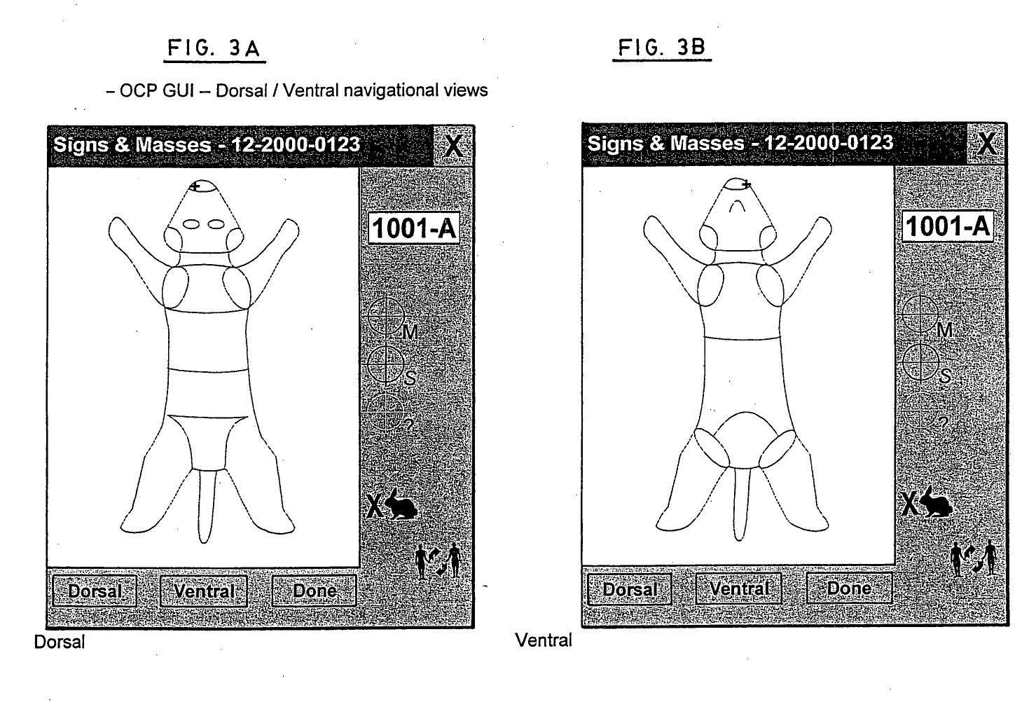

The use of two sided (ventral and dorsal) images to provide localization and lexical validation of each observation made (cf. FIG. 3). This contributes both to the quality (accuracy) of the observation and the intuitiveness of the system. In the drug research setting, this two-sided presentation ensures that simple mistakes such as lateralization (confusing left with right or vice-versa) and use of abdominal finding codes for chest observations are eliminated. In the large equipment maintenance setting, assembly drawings at multiple levels of detail ensure that the correct item is being inspected and both measured and observed using the correct tools. This is expected to reduce the incidences of incorrect part substitutions and inappropriate maintenance actions due to poor training or recent changes to procedures.

By limiting the user's opportunities for error (through the use of pick lists and visual localization), subsequent revisions of the captured data can focus on the analysis and interpretation of the findings rather than substantial quality reviews aimed at confirming that the correct capture protocols, procedures and tools were used. In the drug development application this could reduce data review from three months to two days in the case of most mid-sized studies (studies with an average duration of 6 to 12 weeks).

At an operational level, the use of Test System schematics and application-specific lexicons force the capture operators to provide only “valid” observations and measurements. The required meta information (e.g. date/time stamp of captured data, ID of technician and instrument used to capture data as well as confirmation that the technician performing the operation is currently qualified) is all integrally associated to the data record by the OCP. This has important implications for both the quality of the data captured as well as the overall cost of executing studies given that data verification and correction times are drastically reduced over traditional capture methods.

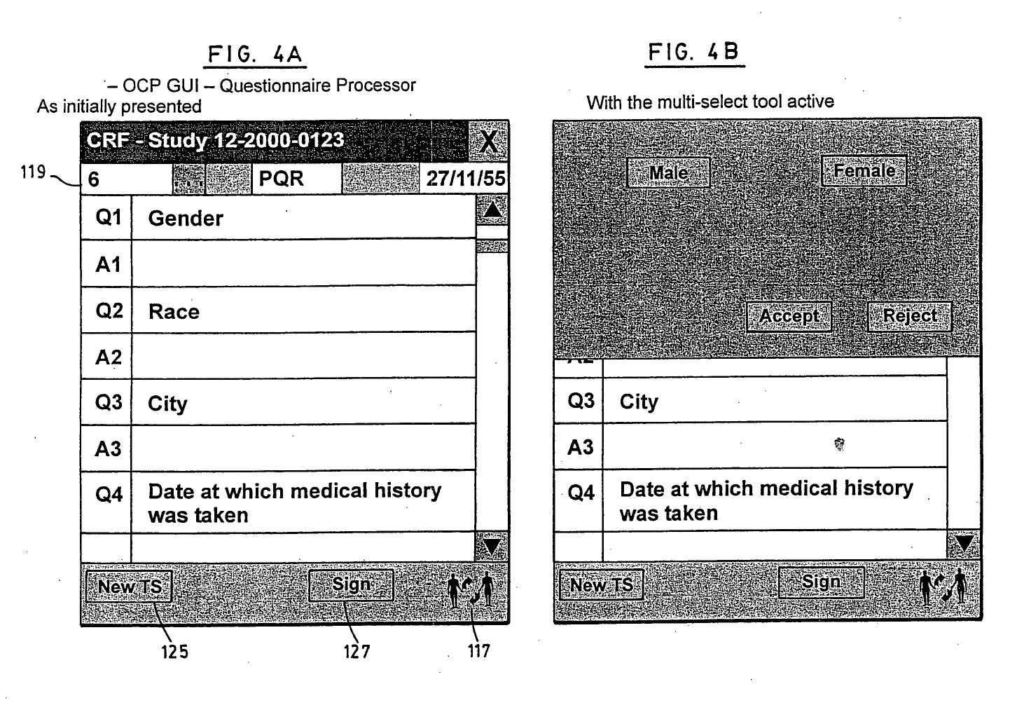

The OCP functions in one of two basic modes with respect to its Graphic User Interface. FIGS. 3 and 4 present the “specialized tool” mode, which incorporates the two-sided graphic that was previously described. This mode is considered a specialized mode as each implementation must be configured to operate with its graphics. FIG. 2 presents the “findings review” function of the “specialized tool” mode. This function tabulates the findings collected in the previous observation cycle. The user is required to review each finding and record whether it is present and unchanged 101, present and changed 103 or not found 105. Reviewed findings are highlighted (shaded in FIG. 2b). When all findings for a Test System have been reviewed, the review function re-labels these command buttons (101, 103, 105) to allow the user to record new observations.

FIGS. 2 and 3 present the “new findings” editor which incorporates the two-sided graphic presentation. With this function enabled, new observations are recorded by tapping the graphic in the area that localizes the site of the finding on the Test System. This action invokes a site specific list of detailed locations from which the user is to select. Once the detailed site is selected, a dialogue tool appears and guides the user through the selection of a finding and appropriate modifiers. The level of detail associated with each observation is established at the time an observation lexicon is defined (using the Planning Station). This detail is particular to each finding for each detailed site of each location.

Beyond the essential collection presentation, the “specialized tool” mode includes a number of support controls:
The Test System selector 107 allows the user to navigate among the pre-set list of Test Systems required to be observed in this cycle. The selector includes controls to select the Next Test System or the Previous Test System. Test Systems can be randomly selected by tapping the current Test System field and selecting from the pull-down list that is presented;
A set of three controls 109, 101, 113 are used to define the specific type of observation being made (i.e. location independent observation, location dependant observation and edit tapped observation respectively);
The Critical Observation tool 115 allows the user to capture critical observations related to Test Systems that are not currently in the Test System selector list; and
The User Swap 117 which allows the user-of-record to be changed in the field.

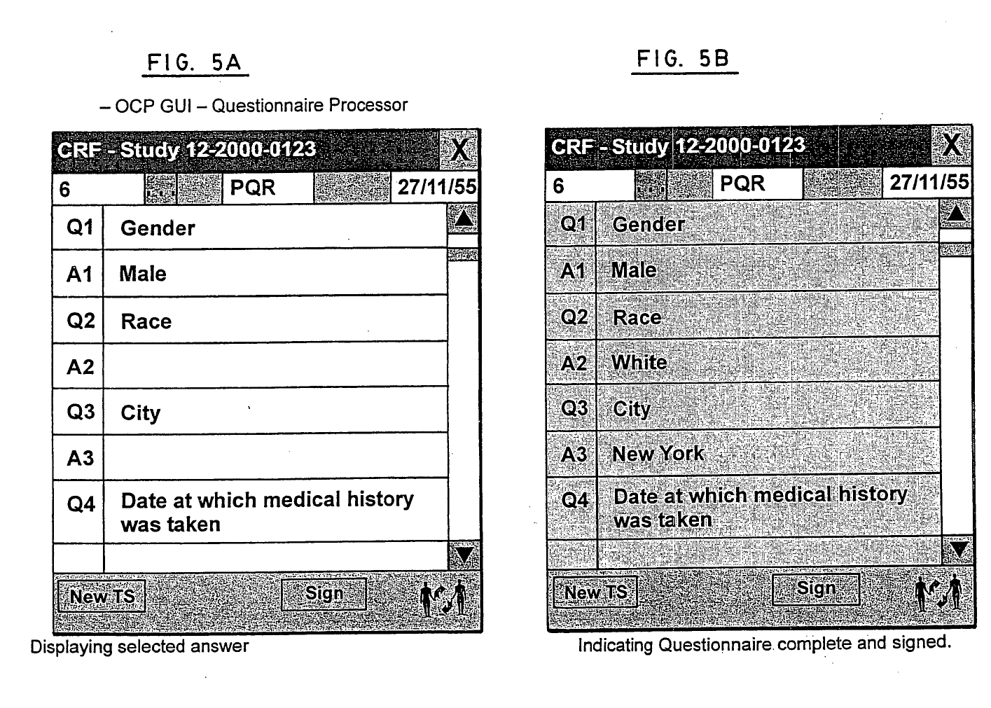

FIGS. 4 and 5 present the Questionnaire Processor mode of the system of the present invention.

This mode is considered the base mode of operation of the system as it requires no “special to task” programming (assuming the required capture tools exists) and can be configured for operation by the users. As its name implies, this mode uses a questionnaire metaphor (i.e. series of questions and answers on a linear form) to guide the user through observations. Each question posed (as presented in FIG. 4) has associated with it a capture tool that is configured with the list of allowable answers. In operation, the user taps the question and is presented with a capture tool (in FIG. 4, the user tapping the word “Gender” would result in the multi-select tool displaying the options “Male” and “Female”) from which he would make his selection.

Capture tools allowing dates, times, numeric values, comments and selection from lists are all presently included in the Questionnaire Processor. As specific instrument interfaces are developed, tools will be programmed and included in the Questionnaire Processor. As with the “findings review” function, highlighting (shading in the drawings) is used to signify that a questionnaire is complete and has been electronically signed by the investigator-of-record.

Peripheral controls for this view include:
The Test System selector 119, 121, 123 which identifies the Test System to which the answers of the questionnaire apply. Navigation among the allowed Test Systems is achieved by tapping the ellipsis button 119 and selecting a Test System from the list presented;
The New TS control 125 allows the user to add a Test System to his list of allowed Test Systems. The availability of this control is determined by the user at the time the form is configured in the Planning Station. Once in the field, the function cannot be independently enabled or disabled;
The Sign control 127 is used by the investigator-of-record to mark the answers collected against a Test System as reviewed and set. Further changes made to these records will be administered by the system's change control system (Audit Trail);
The User Swap 117 which allows the user-of-record to be changed in the field.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for a collection of observations by a plurality of users, said system comprising:
a planning station for preparing work packages of observations to be collected by said users, each work package being tailored to a user profile of a corresponding user;
a plurality of primary capture tools, each associated with one of said users, each of said primary capture tools being adapted to be used to collect observations according to one of said work packages;
at least one download station, in communication with said planning station, for downloading each of said work packages to the primary capture tool associated with the corresponding user; and
at least one upload station, for uploading said observations from each of said primary capture tool.

2. A system according to claim 1, wherein each user profile comprises an access level of said corresponding user.

3. A system according to claim 1, wherein each user profile comprises an expertise level of said corresponding user.

4. A system according to claim 1, wherein each of said work packages comprises an observation procedure, said observation procedure including a lexicon.

5. A system according to claim 4, wherein each of said work packages further comprise support information.

6. A system according to claim 5, wherein said support information comprises at least one element selected from the group comprising technical manuals, standard procedures, tooling set-ups, previous observations, current observation subject configurations and allowed replacement parts.

7. A system according to claim 1, wherein each of said at least one download station comprises authenticating means for authenticating an identity of said users.

8. A system according to claim 7, wherein said authenticating means comprise a password protection.

9. A system according to claim 1, wherein each of said primary capture tools is a hand-held device operating autonomously.

10. A system according to claim 9, wherein each of said primary capture tools is provided with a graphical user interface, said graphical user interface enabling the capture of said observations.

11. A system according to claim 10, wherein said graphical user interface includes an image of a target for which observations are being collected and a pick list, so that when a portion of the image of the target is selected by a user, said pick list narrows the options available to the user to enter as an observation.

12. A system according to claim 11, wherein said pick list is established according to an application specific lexicon.

13. A system according to claim 1, wherein said system further comprises a database server including a data management database, said database server being in communication with said upload station for receiving said observations therefrom.

14. A system according to claim 13, wherein said data management database includes an atomic data structure wherein each of said observations is divided into storage elements each containing a single information.

15. A system according to claim 14, wherein said storage elements comprise pointers linking associated data elements for reconstructing said observations.

16. A method for a collection of observations by a plurality of users, said method comprising the steps of:
a) preparing work packages of observations to be collected by said users, each work package being tailored to a user profile of a corresponding user;
b) downloading each of said work packages to a primary capture tool associated with the corresponding user;
c) having each of said users using the primary capture tool associated therewith to collect observations according to the work package downloaded thereto; and
d) uploading said observations from each of said primary capture tool.

17. A method according to claim 16, wherein each user profile comprises an access level of said corresponding user.

18. A method according to claim 16, wherein each user profile comprises an expertise level of said corresponding user.
